(19) United States
(12) Patent Application Publication
(10) Pub. No.: US 2025/0206906 A1
(43) Pub. Date: Jun. 26, 2025

(54) THERMOCATALYTIC PLASTIC DEPOLYMERIZATION PROCESS

(71) Applicant: Basell Poliolefine Italia S.r.l., Milano (IT)

(72) Inventors: Diego Brita, Ferrara (IT); Simona Guidotti, Ferrara (IT); Dario Liguori, Ferrara (IT); Francesco Menichelli, Ferrara (IT)

(73) Assignee: Basell Poliolefine Italia S.r.l., Milano (IT)

(21) Appl. No.: 18/852,281

(22) PCT Filed: Mar. 30, 2023
(86) PCT No.: PCT/EP2023/058217

§ 371 Date: Sep. 27, 2024

(30) Foreign Application Priority Data
Apr. 4, 2022 (EP) 22166516.9

(51) Int. Cl. C08J 11/16; C04B 7/32

(52) U.S. Cl. CPC C08J 11/16; C04B 7/323; C08J 2323/06; C08J 2323/12

(57) ABSTRACT

A process for depolymerizing plastic waste with a catalyst made from or containing a cement, having an Al2O3/Fe₂O₃ mass ratio equal to or higher than 5.0. A process for depolymerizing plastics, comprising the steps of: a) providing a plastic waste feedstock; b) mixing the plastic waste feedstock with a catalyst, thereby obtaining a reactant mixture; and c) heating the reactant mixture to a temperature ranging from 280° C. to 600° C., thereby obtaining a depolymerization product, wherein the catalyst is a cement, having an Al₂O₃/Fe₂O₃ mass ratio equal to or higher than 5.0.

### FIELD OF THE DISCLOSURE

In general, the present disclosure relates to the field of chemistry. More specifically, the present disclosure relates to polymer chemistry. In particular, the present disclosure relates to a catalytic method for depolymerizing plastic feedstock and to the catalyst for the depolymerization.

### BACKGROUND OF THE DISCLOSURE

For some applications, plastics are inexpensive and durable materials for manufacturing a variety of products. As such, the production of plastics has increased dramatically over the last decades. In some instances, the durability of the plastics contributes to an increase in the amount of plastics in landfill sites and natural habitats. In some instances, degradable and biodegradable plastics persist depending on environmental factors, such as ultraviolet light exposure, temperature, and the presence of microorganisms.

Currently, plastic recycling primarily includes mechanical recycling and chemical recycling. With mechanical recycling, plastics are transformed without changing their chemical structure and may be used to produce new materials. In some instances, mechanical recycling steps include: collecting plastic wastes; sorting plastic wastes by type and color; pressing or milling plastics for packaging plastics; washing and drying plastics; and reprocessing plastics into pellets by agglutinating, extruding, and cooling the plastics. In some instances, the plastics are polyolefins such as polyethylene (PE) and polypropylene (PP).

Alternatively, chemical recycling modifies the structure of plastics, thereby permitting use of the resulting plastics as raw material for different industries or as a basic input or feedstock for manufacturing new plastic products. In some instances, chemical recycling steps include: collecting plastics and heating the plastics to a temperature at which the polymers break down into fragments. In some instances, this process is referred to as depolymerization and converts the plastic waste material to liquid fuel by thermal degradation (cracking) in the absence of oxygen. In some instances, plastic waste is first melted within a stainless steel chamber, under an inert purging gas. Next, the molten material is heated to a gaseous state. Then, the gaseous material is drawn and condensed in one or more condensers, thereby yielding a hydrocarbon distillate made from or containing straight and branched chain aliphatic, cyclic aliphatic, and aromatic hydrocarbons. In some instances, the resulting mixture is used as a fuel. In some instances, the resulting mixture is used as a feedstock in a thermocatalytic process for obtaining refined chemicals such as monomers.

In some instances, the molten plastic mass is converted into a gaseous stream by thermal depolymerization or, in the presence of a catalyst, at a lower temperature.

In some instances, catalysts are selected based on depolymerization tests carried out on virgin polymers or presorted recycled plastics of a single polymer. In some instances, the selected catalysts are fluid catalytic cracking (FCC), zeolites, or silica-alumina catalysts. In some instances, the catalysts are affected adversely by poisoning substances produced during the depolymerization of plastic waste.

### SUMMARY OF THE DISCLOSURE

In a general embodiment, the present disclosure provides a process for depolymerizing plastics, including the steps of:
a) providing a plastic waste feedstock;
b) mixing the plastic waste feedstock with a catalyst, thereby obtaining a reactant mixture; and
c) heating the reactant mixture to a temperature ranging from 280° C. to 600° C., thereby obtaining a depolymerization product;

wherein the catalyst is a cement, having an Al₂O₃/Fe₂O₃ mass ratio equal to or higher than 5.0.

In some embodiments, the amount of catalyst used ranges from 0.1 to 20 wt. %, alternatively 0.1-10 wt. %, alternatively from 0.1 to 5 wt. %, based upon the total weight of plastic waste feedstock and catalyst.

In some embodiments, the plastic waste feedstock is made from or containing a mixture of polyethylene and polypropylene in a weight ratio of 85:15 to 15:85, alternatively 80:20 to 20:80. In some embodiments, the polyethylene is selected from the group consisting of high density polyethylene (HDPE), low-density polyethylene (LDPE), and linear low density polyethylene (LLDPE). In some embodiments, polypropylene (PP) is a propylene homopolymer or a propylene copolymer, having a lower amount of ethylene, butene, or both. In some embodiments, the feedstock is made from or containing other polyolefins like polybutene. In some embodiments, the feedstock also is further made from or containing polymeric mixtures. In some embodiments, the polymeric mixtures are made from or containing other materials selected from the group consisting of polystyrene (PS), ethyl-vinyl acetate copolymer (EVA), ethyl-vinyl alcohol copolymer (EVOH), and polyvinyl chloride (PVC). In some embodiments, the feedstock is made from or containing more than 80% wt of a mixture between polyethylene and polypropylene, wherein polypropylene accounts for more than 50% wt of the polypropylene/polyethylene mixture.

In some embodiments, the depolymerization process occurs in an oxygen-free environment. In some embodiments, an oxygen containing atmosphere is not introduced into the depolymerization system. In some embodiments, a barrier to the potentially oxygen-containing atmosphere is obtained with a series of expedients. In some embodiments, the series of expedients is selected from the group consisting of nitrogen blanketing and a vacuum system connected to a barrel of the extruder.

In some embodiments, the plastic feedstock mixture is charged into the feeding system of the depolymerization reactor by a hopper, or two or more hoppers in parallel. In some embodiments, the oxygen present in the atmosphere of the plastic waste material is eliminated inside the hopper(s).

In some embodiments, the plastic feedstock is fed directly into the depolymerization reactor for small scale tests. In some embodiments and for larger scale, the plastic feedstock is fed to the depolymerization reactor by an extruder.

In some embodiments, the plastic scrap is melted and then injected into the depolymerization reactor. In some embodiments, the extruder receives the plastic scrap cut in small pieces into the feed hopper, conveys the stream in the melting section, and heats the polymer by combined action of mixing energy and heat supplied by barrel heaters. In some embodiments, the melting temperature ranges from 250° C. to 350° C.

In some embodiments, additives are incorporated in the melt. In some embodiments, the additives reduce corrosivity of plastic scrap or improve depolymerization efficiency.

In some embodiments and during the extrusion, one or more degassing steps remove residual humidity present in the product.

In some embodiments and before being fed to the reactor, the melt stream is filtered, thereby removing solid impurities from the plastic waste.

In some embodiments, the extrusion systems are selected from the group consisting of single screw extruders, twin screw extruders, twin screw extruders with gear pump, and combinations thereof.

In some embodiments, mixing of the plastic waste feedstock and catalyst takes place directly into the depolymerization reactor or beforehand, outside the reactor. In some embodiments, the mixing takes place in the depolymerization reactor, wherein the catalyst is fed (a) by pouring directly the solid catalyst into the reactor under a nitrogen atmosphere, or (b) in a form of a liquid hydrocarbon slurry or a semisolid paste using dedicated devices. In some embodiments, the direct-pour method is used in small scale systems.

In some embodiments, the mixing takes place outside the depolymerization reactor, wherein the catalyst is mixed with plastic scrap in a homogenizer apparatus and the mixture is then pelletized. In some embodiments, the pellets are further made from or containing other additives. In some embodiments, the pellets are charged to the extruder hopper, which is used to feed the polymerization reactor. In some embodiments, the plastic scrap and catalysts are charged separately into the hopper. In some embodiments, the mixing takes place into the extruder at the time of plastic scrap melting and the mixture is subsequently fed to the depolymerization reactor.

In some embodiments, the depolymerization reactor is an agitated vessel, operated at temperature ranging from 300° C. to 550° C., alternatively from 350° C. to 500° C., alternatively from 350° C. to 450° C., with an inlet for plastic feedstock and catalyst and an outlet for the gaseous depolymerization product.

In some embodiments and as a result of the depolymerization process, a gaseous stream is generated and sent to a condensation unit, which totally or partially liquefies the stream.

In some embodiments, the condensation section receives effluent gases from the depolymerization reactor and partially condenses the gases into an oily depolymerized product made from or containing hydrocarbons. In some embodiments, a fraction of incondensable gases is collected and stored separately. In some embodiments, the condensation section has one or more stages. In some embodiments, the stages are operated under pressure. In some embodiments, the stages are operated at different temperatures. In some embodiments, the operating conditions of the number of stages, pressure, or temperature permit recovery of the maximum amount of products, according to the volatility of the resulting formed compounds. In some embodiments, the temperature range varies depending on the operating pressure.

In some embodiments, the condensation section has at least two condensation stages. In some embodiments, the condensation stages are operating at descending temperatures. In some embodiments and with small scale equipment, the first condensation stage is operated at a temperature range of 100-120° C. and the second condensation stage is operated at a temperature range of from 2° C. to −20° C.

In some embodiments, the depolymerization product coming from the condensation stage is subjected to a second depolymerization stage carried out in the presence of the cement-based catalyst. In some embodiments, the second depolymerization stage is carried out under similar conditions as the first depolymerization stage. In some embodiments, the catalyst and part of the liquid or semiliquid mass from the second depolymerization reactor are recycled to the first depolymerization reactor from which the solid residue is discharged. In some embodiments, the gaseous effluent is condensed in a subsequent condensation stage.

In some embodiments and at the end of the process at least 80% wt., alternatively at least 90% wt., of the plastic waste feedstock is converted into a liquid or gaseous depolymerization product. In some embodiments, the solid residue of the depolymerization reaction is equal to or lower than 10 wt %, based on the initial plastic waste feedstock.

In some embodiments, the depolymerization product is used as a cracker feedstock. In some embodiments, the depolymerization product is a liquid depolymerization product. In some embodiments, the amount of liquid depolymerization product is higher than 60% wt., alternatively from 65 to 85% wt., of the plastic waste feedstock.

In some embodiments, the liquid depolymerization product is made from or containing a very low amount of fractions with C₂₈ or higher (corresponding to boiling point higher than 434° C.). In some embodiments, the liquid depolymerization product is free of fractions with C₂₈ or higher. In some embodiments, the liquid depolymerization product is made from or containing an amount of the higher than C₂₈ fraction equal to or lower than 6%, alternatively equal to or lower than 5%, with respect to the total amount of liquid depolymerization product.

In some embodiments, the composition of the liquid depolymerization product has a narrow composition distribution. In some embodiments, the liquid depolymerization product is separated into four fractions with boiling points (i) of lower than 98° C., (ii) from 98 to lower than 203° C., (iii) from 203 to 434° C., and (iv) higher than 434° C., wherein one of the two middle fractions is present in an amount higher than 60% wt, alternatively higher than 65% wt, with respect to the total amount of liquid depolymerization product. In some embodiments, the fraction with boiling point from 203 to 434° C. is present in an amount of higher than 60% wt, alternatively of higher than 65% wt, based on the total amount of liquid depolymerization product.

In some embodiments, the depolymerization oil obtained from real plastic waste has low values of C₆-C₈ aromatics and Branch Index. As used herein, the term “Branch Index” is defined as the molar ratio between internal double bonds with respect to double bond in chain end position (alpha-olefins). In some embodiments, the liquid depolymerization product has a Branch Index of no more than 1 wt %, alternatively lower than 1 wt %, alternatively lower than 0.5 wt %.

As used herein, the term “C₆-C₈ aromatics” refers to a hydrocarbon with sigma bonds and delocalized pi electrons between carbon atoms forming a circle, wherein total of 6 to 8 carbon atoms are present.

In some embodiments, the catalyst is made from or containing cement, having a Al₂O₃/Fe₂O₃ mass ratio equal to or higher than 5.

In some embodiments, cement is based on Clinker, which is a mixture of minerals containing silicon, aluminum, and iron oxides (from clay) as well as calcium and magnesium oxides (MgO) (from carbonate rocks).

In some embodiments, Clinker is made from or containing at least ⅔ by mass of calcium silicates such as tricalcium silicate (3CaO·SiO₂) and dicalcium silicate (2CaO·SiO₂), with the remaining part containing aluminum oxide in the form of tricalcium aluminate (3CaO·Al₂O₃), iron oxide in the form of tetracalcium aluminoferrite (4CaO·Al₂O₃·Fe₂O₃), and other oxides in minor amount.

In some embodiments, Clinker has the CaO/SiO₂ mass ratio higher than 2.0. In some embodiments, the content of magnesium oxide (MgO) is lower than 5.0% by mass.

In some embodiments, the Clinker is mixed with other inorganic constituents in amounts from about 1.0% to 95%, alternatively from 4.0 to 70%, alternatively from 5 to 65 wt %, based on the total weight of Clinker and other constituents, thereby producing different types of the final cement powder.

In some embodiments, the Al₂O₃/Fe₂O₃ mass ratio is equal to or higher than 5, alternatively higher than 8, alternatively higher than 10, alternatively higher than 15, alternatively in the range 15-25.

In some embodiments, the CaO/SiO₂ mass ratio of the cement is higher than 2.5, alternatively higher than 3, alternatively in the range 4-8.

In some embodiments, the S03/Fe₂O₃ mass ratio of the cement is equal to or higher than 4, alternatively higher than 5, alternatively higher than 6, alternatively in the range 7-30.

In some embodiments, the amount of Al₂O₃ in the cement is higher than 3 wt %., alternatively higher than 5 wt %., alternatively ranging from 7 to 35 wt %., based on the total weight of cement.

In some embodiments, the amount of S03 in the cement is higher than 3 wt %., alternatively higher than 5 wt %., alternatively ranging from 8 to 30 wt %., based on the total weight of cement.

In some embodiments, the cements are based on sulfo-aluminate clinker.

### Characterization

The properties are determined according to the following methods.

### Analytical Methods

Characterization of liquid products: The liquid products from two traps were characterized by Gas Chromatography (GC) and proton NMR (¹H NMR).

The GC analysis of the liquid product was performed using an Agilent 7890 GC (Agilent Technologies, Santa Clara, CA), equipped with a non-polar column and a flame ionization detector. For the GC data, the weight percent for x<nC₇ (boiling point lower than 98° C.), nC₇<x<nC₁₁ (boiling point from 98 to lower than 203° C.), nC₁₂<x<nC₂₈ (boiling point from 203 to 434° C.), x>C₂₈ (boiling point higher than 434° C.) were used to characterize the liquid product.

NMR data were used to characterize the percent of aromatic protons, paraffinic protons, and olefinic protons in the liquid product. The examples were analyzed with an addition of CDCl₃ (0.6 g of depolymerize polymer/metal oxide mixture with 0.4 g of CDCl₃). The data were collected on a Bruker AV500 MHz NMR spectrometer (Bruker Corporation, Billerica, MA) at 25° C. with a 5 mm Prodigy probe. One dimension ¹H NMR data were processed, using TOPSPIN® software (Bruker) with an exponential line broadening window function. Quantitative measurements were performed with a 15 second relaxation delay, a 300 flip angle pulse, and 32 scans, thereby facilitating integrals. The spectral integrations for aromatic olefinic, and paraffinic protons were obtained and used to quantify relative ratios. The Branch Index is defined as the ratio (II+III)/(I+IV), where I, II, III and IV represent different typologies of H-double bonds according to the following structures:

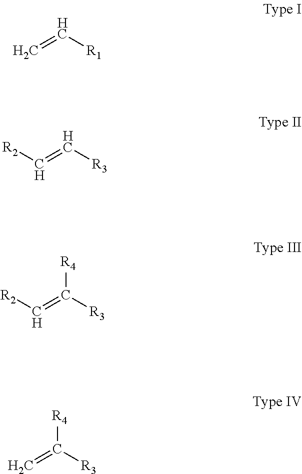

The catalyst used in the depolymerization run were based on commercially available cements, according to the following:

| | | | | Composition | | | | | |
|---|---|---|---|---|---|---|---|---|---|
| | | | SiO₂ | Al₂O₃ | Fe₂O₃ | CaO | MgO | SO₃ | Al₂O₃/ |
| Ex. | Name | Provider | (wt %) | (wt %) | (wt %) | (wt %) | (wt %) | (wt %) | Fe₂O₃ |
| C1 | Portland | Buzzi | 14.4 | 3.97 | 2.22 | 60.9 | 1.16 | n.d. | 1.78 |
| | cement | | | | | | | | |
| C2 | Pozzolanic | CACEM | 24.4 | 7.56 | 3.00 | 47.46 | 1.41 | n.d. | 2.52 |
| 1 | Ali CEM | Italcementi | 5.76 | 23.08 | 1.06 | 40.09 | 3.28 | 23.1 | 21.77 |
| | Green | | | | | | | | |
| 2 | Ali Pre | Italcementi | 7.68 | 30.77 | 1.41 | 39.45 | 4.37 | 11.4 | 21.82 |
| | Green | | | | | | | | |
| 3 | ItalBianco | Italcementi | 21.62 | 3.61 | 0.23 | 66.30 | 0.81 | 3.31 | 15.69 |

The determination of Si, Al, Fe, Ca, and Mg content in the catalyst was carried out via inductively coupled plasma emission spectroscopy on “I.C.P Spectrometer ARL Accuris”.

The sample was prepared by analytically weighing, in a “Fluxy” platinum crucible”, about 0.1 grams of catalyst and 2 grams of lithium metaborate/tetraborate 1/1 mixture. After addition of some drops of KI solution, the content of the crucible was subjected to complete burning. The residue was collected with a 5% v/v HNO₃ solution and then analyzed via ICP at the following wavelengths: Si=212.41 nm, Al=394.4 nm, Fe=259.94 nm, Ca=396.85 nm or 393.36 nm, Mg=279.08 nm or 285.21 nm.

### EXAMPLES

### Depolymerization Procedure

### Procedure for Depolymerization Test in a 500 ml Round Glass Reactor

30 g of the polymer plastic were loaded in a 500 mL round glass reactor, having three necks equipped with thermocouple and nitrogen inlet. Polymer plastic waste was derived from pre-sorted municipal collection and determined to be made from or containing about 97 wt % of polyolefin, wherein the PP/PE ratio was about 42/55, with the residual containing traces of other polymers (PET, PS, PA, or PU) and inorganic contaminants.

The solid catalyst (2.5 wt % with respect to plastics) was then introduced into the glass reactor. A blank test without any catalyst was performed. Two glass condensers were connected in series and kept at 110° C. and −8° C., respectively, using an oil bath (Cryostat Julabo). The reactor was placed in electrically heating system (mantle bath). The temperature was raised up to 450° C. The pyrolysis process took place. The following experimental parameters were recorded:
L %, sum of the yield of liquid condensable at 110° C.+liquid condensable at −8° C. (with respect to the polymer charged)
S %, yield of solid/waxy residue in the reactor, excluding catalyst (with respect to the polymer charged)
G %, yield in gaseous products not condensable in both condensers (with respect to the polymer charged)

The results are reported in Table 1.

TABLE 1

| | | | | | | 98° C. < | 203° C. < | | |
|---|---|---|---|---|---|---|---|---|---|
| | | | | | BP < | BP < | BP < | BP > | |
| Ex | Catalyst | S. | L. | G. | 98° C. | 203° C. | 434° C. | 434° C. | Branch. |
| # | type | wt. % | wt. % | wt. % | wt. % | wt. % | wt. % | wt. % | Index |
| Control | No | 24 | 60 | 16 | 1.0 | 36.5 | 60.5 | 2.0 | 0.155 |
| Comp. 1 | C1 | 15 | 69 | 16 | 1.0 | 40.2 | 58.3 | 0.5 | 0.155 |
| Comp. 2 | C2 | 17 | 65 | 18 | 2.0 | 40.0 | 55.0 | 3.0 | 0.146 |
| 1 | 1 | 10 | 72 | 18 | 1.0 | 25.0 | 70.0 | 4.0 | 0.144 |
| 2 | 2 | 9 | 70 | 21 | 0.5 | 23.5 | 72.5 | 3.5 | 0.154 |
| 3 | 3 | 10 | 70 | 20 | 1.0 | 26.0 | 68.0 | 5.0 | 0.143 |

What is claimed is:

1. A process for depolymerizing plastics, comprising the steps of:
a) providing a plastic waste feedstock;
b) mixing the plastic waste feedstock with a catalyst, thereby obtaining a reactant mixture; and
c) heating the reactant mixture to a temperature ranging from 280° C. to 600° C., thereby obtaining a depolymerization product; wherein the catalyst is being a cement, having an Al₂O₃/Fe₂O₃ mass ratio equal to or higher than 5.0.

2. The process of claim 1, wherein the amount of catalyst ranges from 0.1-20 wt. %, based upon to the total weight of plastic waste feedstock and catalyst.

3. The process according to claim 1, wherein the plastic waste feedstock comprises a mixture of polyethylene and polypropylene in a weight ratio of 85:15 to 15:85.

4. The process according to claim 1, wherein the cement has the Al₂O₃/Fe₂O₃ mass ratio of higher than 8.

5. The process according to claim 4, wherein the Al₂O₃/Fe₂O₃ mass ratio ranges from 15 to 25.

6. The process according to claim 1, wherein the cement further comprises CaO and SiO₂ and has a CaO/SiO₂ mass ratio higher than 2.5.

7. The process according to claim 1, wherein the cement further comprises SO₃ and has a SO₃/Fe₂O₃ mass ratio equal to or higher than 4.

8. The process according to claim 7, wherein the SO₃/Fe₂O₃ mass ratio of the cement ranges from 7 to 30.

9. The process according to claim 1, wherein the amount of Al₂O₃ in the cement is higher than 3% wt, based on the total weight of cement.

10. The process according to claim 9, wherein the amount of Al₂O₃ in the cement ranges from 7 to 35% wt., based on the total weight of cement.

11. The process according to claim 1, wherein the cement further comprises SO₃ in an amount higher than 3% wt., based on the total weight of cement.

12. The process according to claim 1, wherein the cement is based on a sulfo-aluminate clinker.

13. The process according to claim 1, wherein the depolymerization product comprises liquid depolymerization product in an amount higher than 60% wt., of the plastic waste feedstock.

14. The process according to claim 1, wherein the depolymerization product comprises liquid depolymerization product, having a fraction with boiling point from 203 to 434° C. in an amount higher than 60% wt, based on the total amount of liquid depolymerization product.

15. The process according to claim 1, wherein the depolymerization product comprises liquid depolymerization product, having a Branch Index of no more than 1% wt.
